(19) United States
(12) Patent Application Publication
(10) Pub. No.: US 2006/0047638 A1
(43) Pub. Date: Mar. 2, 2006

(54) Cartesian product detection

(75) Inventors: Richard D. Dettinger, Rochester, MN (US); Daniel P. Kolz, Rochester, MN (US); Richard J. Stevens, Rochester, MN (US); Jeffrey W. Tenner, Rochester, MN (US)

Correspondence Address: IBM CORPORATION;DEPT 917, 3605 HIGHWAY 52 NORTH, ROCHESTER, NY, 55901-7829, US

(73) Assignee: INTERNATIONAL BUSINESS MACHINES CORPORATION, ARMONK, NY (US)

(21) Appl. No.: 10/932,709

(22) Filed: Sep. 2, 2004

(51) Int. Cl. G06F 17/30

(52) U.S. Cl. 707/3

(57) ABSTRACT

A method, system and article of manufacture for query processing and, more particularly, for determining that Cartesian Products will occur in query results without executing corresponding queries. One embodiment provides a method for detecting Cartesian Products in query results. The method comprises identifying, from a query against one or more databases, joins between different tables of the one or more databases. Without executing the query against the one or more databases, it is determined on the basis of cardinalities of the identified joins whether a Cartesian Product will occur in a query result corresponding to the query.

### CROSS-RELATED APPLICATION

This application is related to the following commonly owned application: U.S. patent application Ser. No. 10/083,075, filed Feb. 26, 2002, entitled “APPLICATION PORTABILITY AND EXTENSIBILITY THROUGH DATABASE SCHEMA AND QUERY ABSTRACTION”, which is hereby incorporated herein in its entirety.

### BACKGROUND OF THE INVENTION

1. Field of the Invention

The present invention generally relates to query processing and, more particularly, to determining whether Cartesian Products will occur in query results.

1. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a DBMS can be structured to support a variety of different types of operations. Such operations can be configured to retrieve, add, modify and delete information being stored and managed by the DBMS. Standard database access methods support these operations using high-level query languages, such as the Structured Query Language (SQL). The term “query” denominates a set of commands that cause execution of operations for processing data from a stored database.

One of the most common executed SQL queries is the SELECT statement. A SELECT statement generally has the format: “SELECT<clause> FROM<clause> WHERE<clause> GROUP BY<clause> HAVING<clause> ORDER BY <clause>”. The clauses must generally follow this sequence. Only the SELECT and FROM clauses are required and all other clauses are optional. The result of a SELECT statement is, in general, a subset of data retrieved from one or more existing tables stored in a relational database. The subset of data defines a query result which is treated as a new table, termed the result table. The WHERE clause determines which rows should be returned in the result table. Generally, the WHERE clause contains one or more query conditions that must be satisfied by each row returned in the result table. The FROM clause identifies the name of the existing table(s) from which the result table is being determined. Thereby, the FROM clause may define an implicit join operation. More specifically, a given SQL query may not contain a specific join keyword or statement, but may simply be configured to select data from multiple database tables. Thus, the information from the multiple tables is joined by appending information from one table to information in another. Accordingly, rows or portions of rows from the multiple tables are concatenated along the rows (e.g., if a row of a first table contains “abc” and a row of a second table contains “xyz”, the join results in a row containing “abc xyz”).

Any requesting entity, including applications, operating systems and, at the highest level, users, can issue queries against data in a database to obtain required information. Queries may be predefined (i.e., hard coded as part of an application) or generated in response to input (e.g., user input). Upon execution of a query against a database, a query result is returned to the requesting entity. The requesting entity may thus analyze the query result to identify the required information therefrom.

One difficulty when analyzing query results is the occurrence of Cartesian Products in the query results. A Cartesian Product is an operation between two result sets forming a single query result. For instance, assume that upon execution of a given query against one or more databases a first result set RS1 is determined from a first database table and a second result set RS2 is determined from a second database table. Assume further that RS1={1, 2} and that RS2={“string”, “abc”}. In order to return both result sets in the form of a single query result, the Cartesian Product of RS1 and RS2 is determined. This is an operation that is performed to return a single query result consisting of all tuples of values read out from both result sets, i.e., RS1×RS2={1,2}×{“string”, “abc”}={<1, “string”>, <1, “abc”>, <2, “string”>, <2, “abc”>}. In other words, the Cartesian Product RS1×RS2 can be generated by arranging every element of RS1 and RS2 with a double loop structure, generating and registering each tuple of elements, and adding each tuple to the single query result.

However, such Cartesian Products may render the query results useless to requesting entities which issued the corresponding queries. For example, assume a user in a hospital who wants to determine all medical tests which have been performed on a given patient “Bob” and all diagnoses that have been established for this patient. To this end, the user may specify the following exemplary SQL query:

TABLE I
EXEMPLARY SQL QUERY

| | |
|---|---|
| SELECT | T1.ID, T1.Name, |
| | T2.Value AS Test, |
| | T3.Value AS Diagnosis |
| FROM | Demographic T1, |
| | Test T2, |
| | Diagnosis T3 |
| WHERE | T1.Name = ‘Bob’ AND |
| | T1.ID = T2.ID AND |
| | T1.ID = T3.ID |

In the given example, the FROM clause of the exemplary SQL query defines an implicit join operation with respect to the database tables “Demographic” (as T1), “Test” (as T2) and “Diagnosis” (as T3). The WHERE clause indicates the columns (i.e., “T1.ID”, “T2.ID” and “T3.ID”) through which the tables to be joined (i.e., “Demographic”, “Test” and “Diagnosis”) are linked. Exemplary “Demographic”, “Test” and “Diagnosis” database tables are shown below:

“Demographic” table:

| ID | Name |
|---|---|
| 1 | Bob |
| 2 | Fred |
| 3 | Jane |

| | | |
|---|---|---|
| ID | Value | Date |

“Test” table:

| | | |
|---|---|---|
| 1 | 32 | Jan. 2, 2004 |
| 1 | 12 | Jan. 3, 2004 |
| 2 | 22 | Jan. 4, 2004 |
| 2 | 31 | Jan. 5, 2004 |
| 3 | 15 | Jan. 6, 2004 |

“Diagnosis” table:

| | | |
|---|---|---|
| 1 | Cancer | Jan. 2, 2004 |
| 1 | Ulcer | Jan. 3, 2004 |
| 2 | Liver Failure | Jan. 4, 2004 |
| 3 | Baldness | Jan. 5, 2004 |
| 3 | Common Cold | Jan. 6, 2004 |

In the given example, the following query result is obtained after execution of the exemplary SQL query against the exemplary “Demographic”, “Test” and “Diagnosis”database tables:

| ID | Name | Test | Diagnosis |
|---|---|---|---|
| 1 | Bob | 32 | Cancer |
| 1 | Bob | 12 | Cancer |
| 1 | Bob | 32 | Ulcer |
| 1 | Bob | 12 | Ulcer |

As can be seen from the query result, a Cartesian Product containing all possible combinations of rows from the joined database tables is obtained after execution of the exemplary SQL query. This Cartesian Product renders the query result useless as the user is not able to establish a relation between the “Test” and “Diagnosis” values without additional information. Specifically, the user is misled into thinking that the Test value “32” is related to the Diagnosis “Cancer” or the Diagnosis “Ulcer”. Thus, the user's time and computer resources have been wasted, as they did not lead to a satisfying result in a reasonable amount of time.

Therefore, there is a need for an efficient technique for determining whether Cartesian Products will occur in query results before executing queries.

### SUMMARY OF THE INVENTION

The present invention is generally directed to a method, system and article of manufacture for query processing and, more particularly, for determining whether Cartesian Products will occur in query results without executing corresponding queries.

One embodiment provides a method for detecting Cartesian Products in query results. The method comprises identifying, from a query against one or more databases, joins between different tables of the one or more databases. Without executing the query against the one or more databases, it is determined on the basis of cardinalities of the identified joins whether a Cartesian Product will occur in a query result corresponding to the query.

Another embodiment provides a computer-readable medium containing a program which, when executed by a processor, performs a process for detecting Cartesian Products in query results. The process comprises identifying, from a query against one or more databases, joins between different tables of the one or more databases. Without executing the query against the one or more databases, it is determined on the basis of cardinalities of the identified joins whether a Cartesian Product will occur in a query result corresponding to the query.

Still another embodiment provides a computer system comprising one or more databases and a query manager. The query manager is configured for identifying, from a query against the one or more databases, joins between different tables of the one or more databases. Without executing the query against the one or more databases, it is determined on the basis of cardinalities of the identified joins whether a Cartesian Product will occur in a query result corresponding to the query.

Still another embodiment provides a method for detecting Cartesian Products in query results, including constructing a join graph, for a query, representing joins between a plurality of tables of one or more databases; traversing the join graph from one table to another table for each of the plurality of tables; and determining, on the basis of the traversing and without executing the query, whether a predetermined type of condition exists in the join graph which is capable of contributing to a resulting Cartesian Product in a query result corresponding to the query.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a relational view of software components in one embodiment;

FIG. 2A is a relational view of components implementing one aspect of the invention;

FIGS. 2B-D are illustrations of exemplary join graphs according to aspects of the invention; and

FIG. 3 is a flow chart illustrating a method for managing creation of a query in one embodiment.

### DETAILED DESCRIPTION OF THE PREFERRED EMBODIMENTS

Introduction

The present invention is generally directed to a method, system and article of manufacture for query processing and, more particularly, for determining whether Cartesian Products will occur in query results without executing corresponding queries. In one embodiment, the conditions responsible for resulting in Cartesian Products in query results are detected without executing corresponding queries. A Cartesian Product may occur in a query result for a given query if the given query defines a join of multiple different database tables having one-to-many and/or many-to-many relationships. However, joins of multiple different database tables having one-to-one and/or many-to-one relationships will not lead to a Cartesian Product in the query result. Accordingly, the conditions responsible for resulting in the Cartesian Product can be detected by examining the cardinalities of all table joins that occur in the given query. If joins of the one-to-many and/or many-to-many type occur in a certain pattern, the given query will lead to a query result that defines a Cartesian Product. In this case, a user can be informed of the potentially misleading and time consuming nature of the given query. For instance, the query can be flagged with a warning to indicate that it is determined that the Cartesian Product will occur.

It should be noted that the following explanations may refer by way of example to joins having one-to-one or one-to-many relationships. However, it should be noted that reference to joins having one-to-one or one-to-many relationships is merely made for brevity and simplicity and that the described techniques can be similarly applied to joins having many-to-one or many-to-many relationships. Specifically, the techniques described with respect to joins having one-to-one relationships can similarly be applied to joins having many-to-one relationships, and the techniques described with respect to joins having one-to-many relationships can similarly be applied to joins having many-to-many relationships.

In order to detect the conditions responsible for the resulting in the Cartesian Product in the query result, according to one embodiment, a join graph can be constructed after receipt of the given query from a corresponding requesting entity. The join graph is an undirected graph that graphically represents all table joins defined by the given query. In one embodiment, the join graph includes a plurality of nodes, each representing a different database table that is accessed by the given query. The nodes are connected in a manner indicative of a join having cardinalities which define a one-to-one relationship between the underlying database tables and a join having cardinalities which define a one-to-many relationship between the underlying database tables. The join graph can then be analyzed with respect to certain attributes. If these attributes are present, the given query for which the join graph has been constructed would lead to a query result that defines a Cartesian Product, if executed.

Data Processing Environment

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

Embodiments of the invention can be implemented in a hardware/software configuration including at least one networked client computer and at least one server computer. Furthermore, embodiments of the present invention can apply to any comparable hardware configuration, regardless of whether the computer systems are complicated, multi-user computing apparatus, single-user workstations, or network appliances that do not have non-volatile storage of their own. Further, it is understood that while reference may be made to particular query languages, including SQL, the invention is not limited to a particular language, standard or version. Accordingly, persons skilled in the art will recognize that the invention is adaptable -to other query languages and that the invention is also adaptable to future changes in a particular query language as well as to other query languages presently unknown.

Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

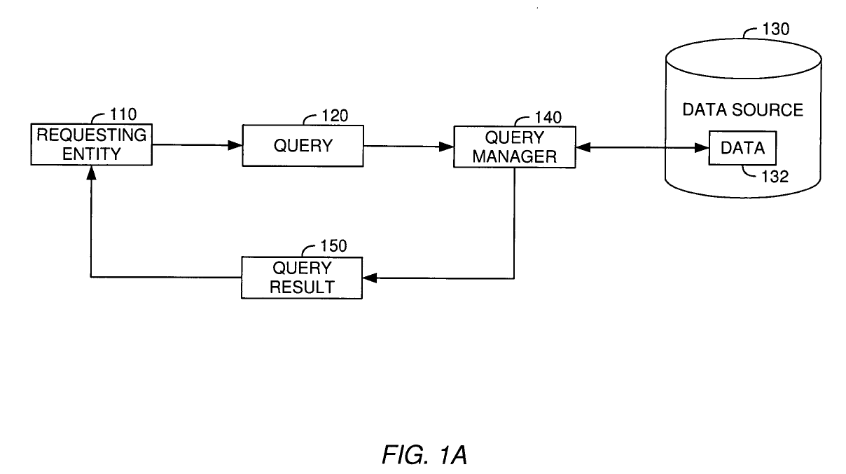

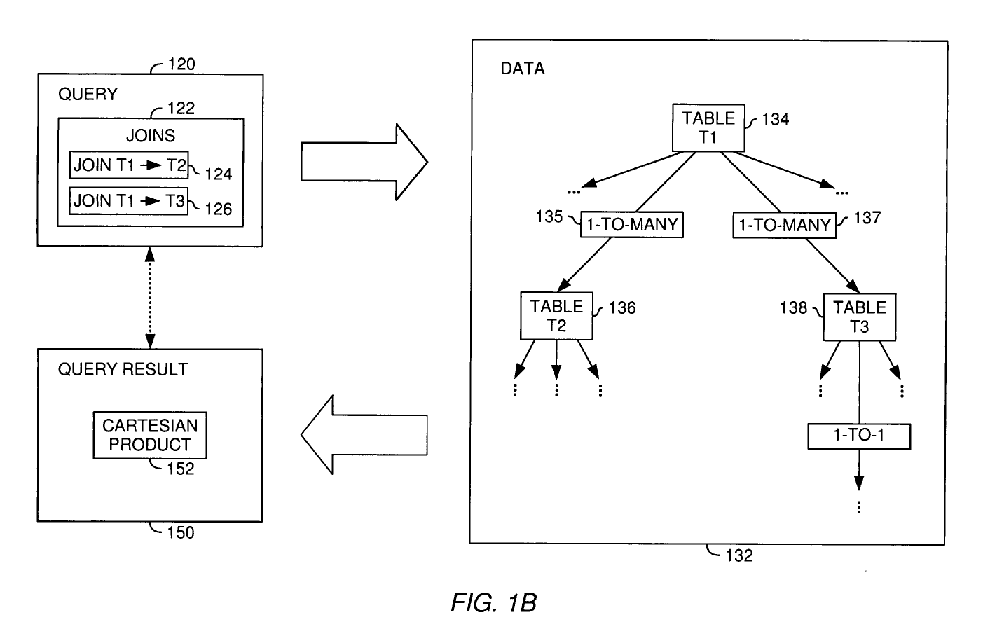

Referring now to FIGS. 1A-B, a relational view of software components in one embodiment is illustrated. According to one aspect, the software components are configured for obtaining a subset of data from a data source. By way of example, reference is made to obtaining the subset of data by issuing a query against a data source, whereby the obtained subset of data is returned as query result. However, it should be noted that any suitable technique for obtaining the subset of data and any suitable subset of data is broadly contemplated.

Illustratively, the software components include a requesting entity 110 and a query manager 140. According to one aspect, the requesting entity 110 issues queries, such as query 120, against data 132 of a data source 130. By way of example, the requesting entity 110 can be embodied by any application, an operating system or, at the highest level, users. The queries issued by the requesting entity 110 may be predefined (i.e., hard coded as part of an application) or may be generated in response to input (e.g., user input).

In one embodiment, the query 120 is an SQL query. In another embodiment, the query 120 is an abstract query. An abstract query is composed using logical fields defined by a data abstraction model. Each logical field is mapped to one or more physical entities of data of an underlying data representation being used in the data source 130 (e.g., XML, SQL, or other type representation). Furthermore, in the data abstraction model the logical fields are defined independently from the underlying data representation, thereby allowing queries to be formed that are loosely coupled to the underlying data representation. The abstract query can be configured to access the data 132 and return query results, or to modify (i.e., insert, delete or update) the data 132. For execution against the data 132, the abstract query is transformed into a form (referred to herein as concrete query) consistent with the underlying data representation of the data 132. Transformation of abstract queries into concrete queries is described in detail in the commonly owned, co-pending U.S. patent application Ser. No. 10/083,075, entitled “Application Portability And Extensibility Through Database Schema And Query Abstraction,” filed Feb. 26, 2002, which is incorporated by reference in its entirety.

The data source 130 is representative of any collection of data regardless of the particular physical representation. In one embodiment, the data source 130 includes one or more databases. Each of the one or more databases may be organized, for example, according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

The query manager 140 is configured to execute the query 120 against the data 132 of the data source 130 to obtain a query result 150 that may subsequently be presented to the requesting entity 110. However, dependent on the query 120 and the data 132, the query result 150 may define a Cartesian Product 152, as described in more detail below.

In one embodiment, illustrated in FIG. 1B, the data 132 includes a database having a plurality of database tables, including tables 134 “Table T1”, 136 “Table T2” and 138 “Table T3”. However, it should be noted that the tables 134, 136 and 138 may also be contained in different databases which may be stored at different locations. For instance, table 134 can be stored in a database which, in turn, is stored in the data source 130 of FIG. 1A, while the tables 136 and 138 are stored in one or more other databases which are stored in one or more other data sources. Furthermore, the one or more other data sources can be implemented as local or remote data sources. Accordingly, any possible implementation which allows access to the tables 134, 136 and 138 is broadly contemplated.

Referring to FIG. 1B, the query 120 illustratively includes a join specification 122 having a plurality of joins definitions. For brevity, the join specification 122 includes only two exemplary join definitions (hereinafter referred to as “joins”) 124 and 126. Each join 124, 126 specifies two database tables that are to be joined. Assume now by way of example that the two exemplary joins 124 and 126 are the joins which are defined by the exemplary SQL query described above. More specifically, as was noted above, the FROM clause of this exemplary SQL query defines joins between the exemplary database tables “Demographic” (as T1), “Test” (as T2) and “Diagnosis” (as T3). Accordingly, the exemplary join 124 “JOIN T1→T2” defines the join between the “Demographic” table and the “Test” table and the exemplary join 126 “JOIN T1→T3” defines the join between the “Demographic” table and the “Diagnosis” table. The WHERE clause of the exemplary SQL query indicates the columns from the database tables through which the tables are linked (i.e., “T1.ID”, “T2.ID” and “T3.ID”). In other words, the “Demographic”, “Test” and “Diagnosis” tables are linked to each other via their respective “ID” columns.

Illustratively, the join 124 describes a one-to-many (“1-TO-MANY”) relationship between the tables 134 “Table T1” and 136 “Table T2”, while the join 126 describes a one-to-many (“1-TO-MANY”) relationship between the tables 134 “Table T1” and 138 “Table T3”. More specifically, in the given example the “Demographic”table (T1) and the “Test” table (T2) are joined by linking these tables via their respective “ID” columns (“T1.ID=T2.ID”) according to the WHERE clause of the exemplary SQL query. As each value in the “ID” column of the “Demographic” table is a unique identifier which, by way of example, uniquely identifies a corresponding individual, each value may only occur once in the “ID” column. Accordingly, the “ID” column of the “Demographic” table has the cardinality “one”. Each value in the “ID” column of the “Test” table is used to associate a given test value and date to a specific individual. Thus, if more than one test is performed on a given individual on the same date or if one or more tests are performed on different dates, each test/date combination is associated with the “ID” value of the given individual. Accordingly, each “ID” value may occur “many” times in the “ID” column of the “Test” table. Thus, the “ID” column of the “Test” table has the cardinality “many”. Therefore, the join 124 between table 134 “Table T1” and table 136 “Table T2” has cardinalities defining a one-to-many relationship. Similarly, the join 126 between table 134 “Table T1” and table 138 “Table T3” has cardinalities defining also a one-to-many relationship.

In one embodiment, the cardinalities of the relationships are determined using relationship definitions stored in one or more persistent data objects. According to one aspect, the relationship definitions define joins between different database tables and corresponding cardinalities. Illustratively, relationship definitions 135 and 137 are shown, which define the cardinalities of the joins 124 and 126, respectively. An exemplary relationship specification including the relationship definitions 135 and 137 shown in FIG. 1B is shown in Table II below. By way of illustration, the exemplary relationship specification is defined using XML. However, any other language may be used to advantage.

TABLE II
EXEMPLARY RELATIONSHIP SPECIFICATION

001 <Relations >
002 <Link id=“Demographic2Test”
003 source=“Demographic” sourceCardinality=“one”
004 target=“Test” targetCardinality=“many” type=“LEFT” >
005 <LinkPoint source=“ID” target=“ID” />
006 </Link>
007 <Link id=“Demographic2Diagnosis”
008 source=“Demographic” sourceCardinality=“one”
009 target=“Diagnosis” targetCardinality=“many” type=“LEFT” >
010 <LinkPoint source=“ID” target=“ID” />
011 </Link>
012 </Relations >

By way of example, lines 002-006 are associated with the join 124 between the tables 134 “Table T1” and 136 “Table T2” (i.e., the “Demographic” and “Test” tables, respectively). According to line 005, the tables are linked via their respective “ID” columns. According to line 003, the cardinality of the “ID” column in the “Demographic” table (referred to as “source”) is “one” (sourceCardinality=“one”). According to line 004, the cardinality of the “ID” column in the “Test” table (referred to as “target”) is “many” (targetCardinality=“many”). Similarly, the join 126 between tables 134 “Table T1” and 138 “Table T2” (i.e., the “Demographic” and “Diagnosis” tables, respectively) is associated with lines 007-011.

In one embodiment, where the query 120 is an abstract query, the exemplary relationship specification can be included with a corresponding data abstraction model. An exemplary data abstraction model is described in detail in the commonly owned, co-pending U.S. patent application Ser. No. 10/083,075, entitled “Application Portability And Extensibility Through Database Schema And Query Abstraction,” filed Feb. 26, 2002, which is incorporated by reference in its entirety. Alternatively, the relationship definitions can be determined at runtime by an extensive analysis of the underlying database(s). Accordingly, any suitable technique for providing and/or determining the relationship definitions is broadly contemplated.

Furthermore, it should be noted that the joins 124 and 126 between tables 134, 136 and 138 are associated with one-to-many relationships in the given example. Furthermore, the tables 134,136 and 138 are illustratively arranged in a so-called Star schema, i.e., a schema having a central table (“Table T1”) with one or more tables (“Table T2” and “Table T3”) connected thereto. However, as schematically illustrated such joins may also be associated with one-to-one relationships and each table may have other relationships with one or more other database tables, whereby schemas other than a Star schema can be formed, such as a Snowflake schema. A snowflake schema corresponds to several connected Star schemas. Accordingly, any suitable schemas and joins are broadly contemplated.

If the illustrated query 120 is executed against the illustrated data 132, the query result 150 includes the Cartesian Product 152. More specifically, in the given example execution of the exemplary SQL query against the tables 134 “Table T1” and 136 “Table T2” (i.e., the “Demographic” and “Test” tables) leads to a first result set RS1. According to the WHERE clause of the exemplary SQL query, each value of RS1 satisfies the condition “T1.ID=T2.ID”. Accordingly, RS1={32, 12}. Similarly, execution of the exemplary SQL query against the tables 134 “Table T1” and 138 “Table T3” (i.e., the “Demographic” and “Diagnosis” tables) leads to a second result set RS2. According to the WHERE clause of the exemplary SQL query, each value of RS2 satisfies the condition “T1.ID=T3.ID”. Accordingly, RS2={“Cancer”, “Ulcer”}. As was noted above, in order to determine a single query result QR (i.e., the query result 150) from RS1 and RS2, the Cartesian Product (i.e., the Cartesian Product 152) of RS1 and RS2 is built:

$$\begin{matrix}QR = RS1 \times RS2 \\ = \{ 32 , 12 \} \times \{ “ Cancer ” , “ Ulcer ” \} \\ = \{ 〈 32 , “ Cancer ” 〉 , 〈 12 , “ Cancer ” 〉 , \\ 〈 32 , “ Ulcer ” 〉 , 〈 12 , “ Ulcer ” 〉 \}\end{matrix}$$

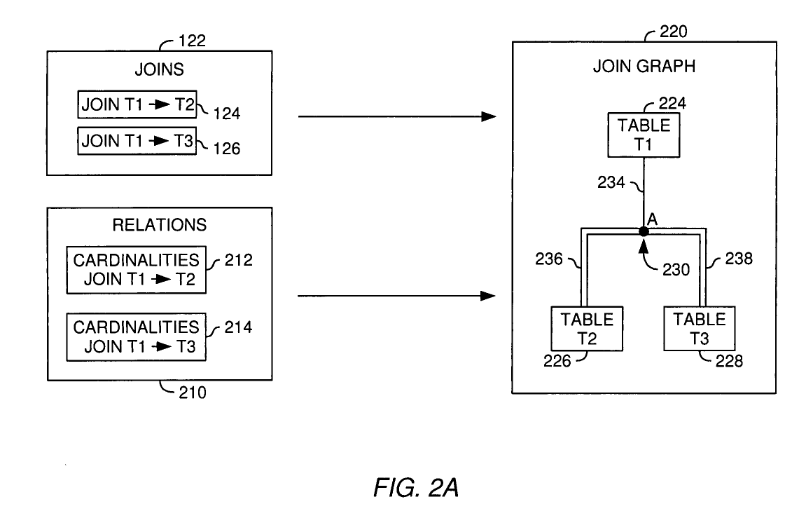

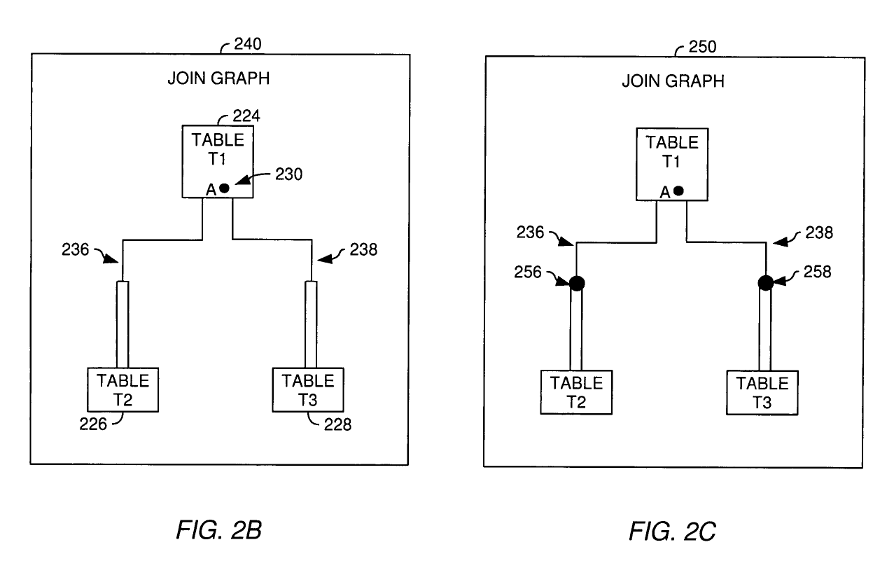

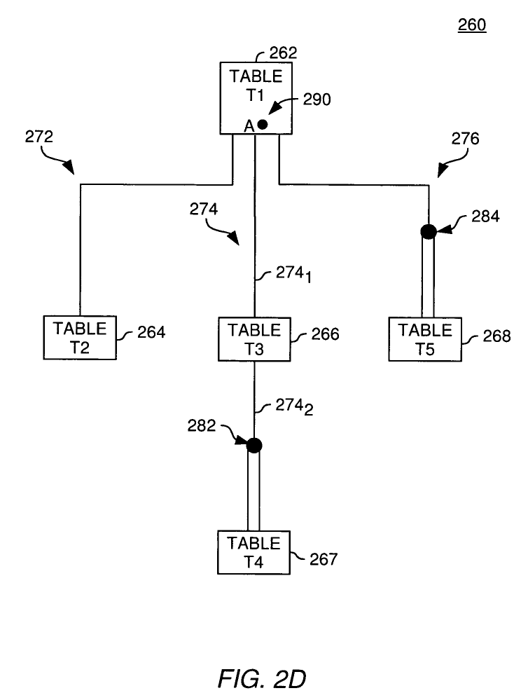

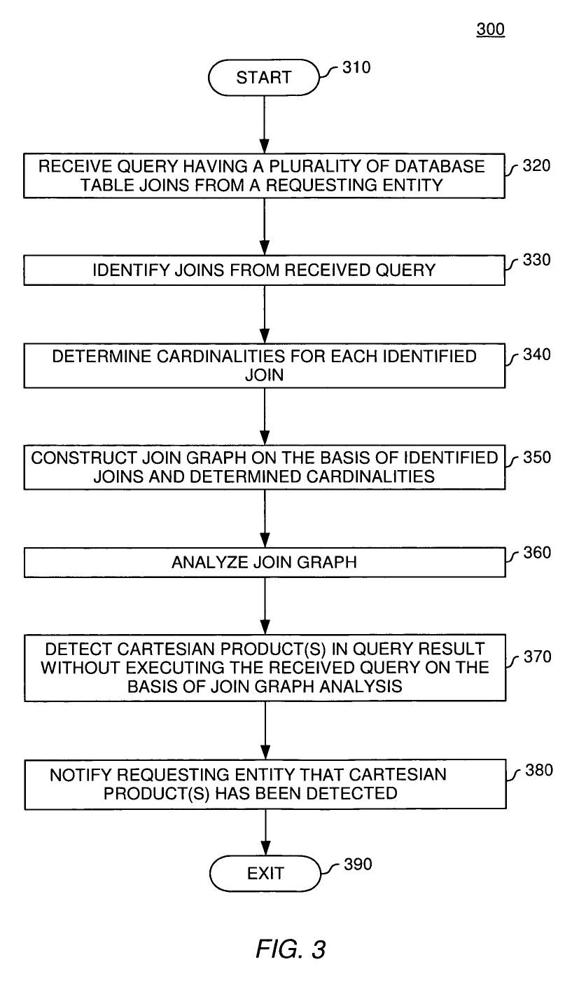

As the query result 150 (i.e., QR) defined by the Cartesian Product 152 (i.e., RS1×RS2) may be useless to the requesting entity 110, the query manager 140 is configured to determine whether the Cartesian Product 152 will occur in the query result 150 in one embodiment before execution of the query 120 against the data 132. Operation of the query manager 140 for determining whether Cartesian Products will occur in query results without execution of corresponding queries is explained in more detail below with reference to FIGS. 2-3.

Referring now to FIG. 2A, one embodiment of a join graph 220 is illustrated. The join graph 220 allows for detection of conditions responsible for resulting in Cartesian Products (e.g., Cartesian Product 152 of FIG. 1B) in query results (e.g., query result 150 of FIG. 1B) without execution of corresponding queries (e.g., query 120 of FIG. 1B). As was noted above, a join graph is an undirected graph where each node is an instance of a database table that is used to provide data for a query result corresponding to a given query. Nodes are connected by edges. Each edge indicates a cardinality that identifies for a given data element in one table, how many data elements possibly correspond to it in a corresponding joined table. In general, the cardinality can be “one” or “many”.

In the given example, reference is made to three different tables, i.e., “Demographic”, “Test” and “Diagnosis”. Accordingly, three nodes as instances of these database tables are created. It should be noted that these tables are explicitly referred to in the given exemplary SQL query, which uses one instance of each table. However, it should be noted that queries can be provided which use more than one instance of a given table. For instance, assume the exemplary SQL query illustrated in Table III below.

TABLE III
EXEMPLARY SQL QUERY

001 SELECT *
002 FROM Demographic t1
003 LEFT JOIN (SELECT * FROM Test WHERE type = 1) AS t2
004 ON t1.id = t2.id
005 LEFT JOIN (SELECT * FROM Test WHERE type = 2) AS t3
006 ON t1.id = t3.id

Even though only two tables (i.e., “Demographic” and “Test” in lines 002, 003 and 005) are explicitly mentioned, the exemplary SQL query of Table IlIl uses three table instances, i.e., an instance of the table “Demographic” (line 002) and two instances of the “Test” table (lines 003 and 005). Accordingly, a corresponding join graph would include three nodes. Between the instance of the “Demographic” table and each instance of the “Test” table a one-to-many relationship exists. In other words, for each row in the “Demographic” table, there can be many rows in the “Test” table. However, for purposes of simplicity and brevity, the following explanations make reference to the given example of the exemplary SQL query of Table I which makes explicit reference to the three database tables “Demographic”, “Test” and “Diagnosis”, and not to the SQL query of Table III.

In the given example with the three database tables “Demographic”, “Test” and “Diagnosis”, the join graph 220 is built using the join specification 122 and a corresponding relationship specification 210. As was noted above, the join specification 122 includes the join 124 of FIG. 1B between the “Demographic” and “test” tables and the join 126 of FIG. 1B between the “Demographic” and “Diagnosis” tables. The relationship specification 210 includes, for each of the joins 124 and 126, a definition of the relationship between the respective tables which are identified by the corresponding join. According to one aspect, each definition describes the cardinalities of two joined database tables. Accordingly, each definition can be determined using appropriate relationship definitions (e.g., relationship definitions 135, 137 of FIG. 1B). Illustratively, the definition 212 describes the cardinalities of the tables which are joined according to the join 124 and the definition 214 describes the cardinalities of the tables which are joined according to the join 126. In other words, both definitions 212 and 214 include the cardinalities “one” for the “Demographic” table and “many” for the “Test” and “Diagnosis” table, respectively.

In one embodiment, where the database tables are connected according to a star schema, a star point is determined in order to build the join graph 220. The star point is a point which is connected with multiple tables. In other words, the star point is a link point which is used to link different database tables to be joined. By way of example, the star point can be defined by a primary key of a parent table to which multiple child tables are joined using foreign keys. Illustratively, the join graph 220 includes a star point 230 “A”. In the given example, the star point 230 “A” represents the “ID” column of the “Demographic” table which is used to join the “Test” and “Diagnosis” tables to the “Demographic” table.

Furthermore, one node is created for each table. In the given example, a node 224 is created for the “Demographic” table (“Table T1”), a node 226 is created for the “Test” table (“Table T2”), and a node 228 is created for the “Diagnosis” table (“Table T3”). Moreover, branches are created from the star point 230 to each of the nodes 224, 226 and 228 according to the defined joins 124 and 126. Each branch is created according to corresponding cardinalities, which are determined from the definitions 212 and 214. More specifically, in one embodiment each branch representing a one-to-many relationship is represented as an edge illustrated by a single line next to the table instance that has the cardinality of one, changing to a double line by the table instance having the cardinality of many; and each branch representing a one-to-one relationship is represented as an edge illustrated by a single line. If two nodes are connected via a star point, the relationship between both nodes is graphically represented as two separate relationships: (i) a first branch connecting one of the nodes with the star point for representing a first relationship, and (ii) a second branch connecting the star point with the other node for representing a second relationship. For instance, assume a first node which is in a one-to-many relationship to a second node. This one-to-many relationship between both nodes is graphically represented as a one-to-one relationship (i.e., a single lined branch) between the first node and the star point and a one-to-many relationship (i.e., a double lined branch) between the star point and the second node. Accordingly, in the given example node 224 is connected to the star point 230 by a single lined branch 234 and the nodes 226 and 228 are connected to the star point 230 by double lined branches 236 and 238, respectively.

It should be noted that the illustrated join graph 220 only includes three nodes representing the three tables “Demographic”, “Test” and “Diagnosis” and three branches 234, 236 and 238. However, in other embodiments join graphs having more nodes and more branches can be created. Furthermore, a given branch may connect a series of nodes to a given star point. For instance, assume that in the illustrated example the branch 236 further connects a node representing a table “Table T4” to the node 226 and so forth, as described in more detail below with reference to FIG. 2D. Thus, it is understood that the join graph 220 has merely been illustrated by way of example and is not limiting of the invention. Moreover, it should be noted that the given example has been described with respect to a star schema. However, other schemas such as a snowflake schema are also contemplated. Specifically, in the case of a snowflake schema more than one star point can be determined.

In one embodiment, each branch in the join graph 220 associated with a given query is traversed to identify double lined branches and, thus, one-to-many joins. If more than one branch includes a one-to-many join, the given query will result in a Cartesian Product, if executed. In the given example, two branches include one-to-many joins, i.e., the branches 236 and 238. Accordingly, the exemplary SQL query would result in a Cartesian Product, if executed. Therefore, a corresponding requesting entity (e.g., requesting entity 110 of FIG. 1A) which issued this query can be notified so that execution of the query can be avoided. By way of example, notifying the requesting entity includes associating a warning flag with the query to indicate the potentially useless, misleading, and time consuming nature of the query to the requesting entity.

However, it should be noted that the direction of traversal of the branches of the join graph 220 may influence the detection of the conditions resulting in the Cartesian Product. For instance, if the join graph 220 is traversed from node 226 via node 224 to node 228, no conditions resulting in the Cartesian Product are detected. More specifically, if the branch 236 is traversed from node 226 in the direction of node 224, a many-to-one join is identified, which is not relevant for detection of the conditions resulting in the Cartesian Product. Furthermore, traversal of the branch 238 from node 224 to node 228 results in identification of a one-to-many join, as described above. In this case, only a single N-to-many (specifically, one-to-many) join is identified and, accordingly, no conditions responsible for resulting in the Cartesian Product are detected (i.e., the query will not result in a Cartesian Product). Therefore, in order to detect the conditions responsible for resulting in the Cartesian Product, a starting point for traversal of all branches of the join graph 220 is determined before identifying the cardinalities of the joins.

In one embodiment, the starting point is a star point. As was noted above, the star point is a point which is connected with multiple tables. In other words, the star point is a point where multiple child tables are connected to a common parent table. Accordingly, in the join graph the star point connects multiple child nodes to a common parent node. From the star point, the direction of traversal is from the parent node to each child node. Accordingly, in the illustrated example, each branch of the join graph 220 is traversed departing at the node 224, i.e., where the star point 230 “A” is located. Departing at node 224 a one-to-many join is identified in each of the branches 236 and 238. Accordingly, the conditions responsible for resulting in the Cartesian Product are detected.

The example described above refers to a single star point. In other cases, a join graph may have multiple star points, or no star points. If multiple star points are included in a given join graph, multiple parent-child relations are defined. In this case, traversal is performed from each parent node (i.e., each node corresponding to a star point). Accordingly, for each parent node, all corresponding parent-child relations are traversed to identify corresponding one-to-many joins. Furthermore, if no star point is included with a given join graph, for instance in a snowflake schema, the direction of traversal can be determined with respect to so-called “inner” tables or nodes, which are similar to parent tables or nodes. In this case, the direction of traversal departs from the inner node(s) to corresponding so-called “outer” nodes, which are similar to child tables or nodes. More specifically, traversal from each inner node to each outer node is performed to detect conditions responsible for resulting in a Cartesian Product. In each case, all branches are traversed to discover “problem locations”, i.e., joins which may contribute to a resulting Cartesian Product.

Referring now to FIG. 2B an alternative representation of the join graph 220 is shown, and is referenced as join graph 240. The alternative representation is intended to facilitate illustration of other aspects of the invention. Accordingly, the branches 236 and 238 are shown separate from each other for clarity. Illustratively, the star point 230 “A” is included with the node 224 to indicate that traversal of the branches 236 and 238 should be performed departing from the node 224 in the direction of the nodes 226 and 228, respectively. Accordingly, as was described above, when departing from the star point 230 in the join graph 240, a one-to-many join is identified in each of the branches 236 and 238. The particular locations in the join graph 240 that give rise to a resulting Cartesian Product are highlighted in the branches 236 and 238 using respective indicators 256 and 258, as shown in FIG. 2C.

As was noted above, a given branch may include a plurality of nodes. By way of example, FIG. 2D shows an illustrative join graph 260 having one branch that includes more than one node. The join graph 260 illustratively includes five nodes 262, 264, 266, 267 and 268 representing tables “Table T1” to “Table T5”, respectively. The nodes 264-268 are connected to the node 262 via a star point 290 “A”, which is illustratively included with node 262. More specifically, the node 264 “Table T2” is connected to the node 262 via a branch 272, which represents a one-to-one join. The nodes 266 “Table T3” and 267 “Table T4” are connected to the node 262 via a branch 274. By way of example, the branch 274 includes two edges 274₁ and 274₂. The first edge 274₁ represents an illustrative one-to-one join between the nodes 262 and 266. The second edge 274₂ represents an illustrative one-to-many join between the nodes 266 and 267. The node 268 “Table T5” is connected to the node 262 via a branch 276, which represents a one-to-many join. In this case, the particular locations in the join graph 260 that give rise to a resulting Cartesian Product are identified between nodes 266 and 267 and nodes 262 and 268. Accordingly, these particular locations are highlighted in the branches 274 and 276 using respective indicators 282 and 282.

Having determined the “problem locations” in a join graph, it is contemplated that corrective action may be taken to prevent a Cartesian Product from occurring. In one embodiment, corrective action may be taken with respect to only some of the identified N-to-many joins. More specifically, corrective action may be taken with respect to all but one of the identified N-to-many joins, since a Cartesian Product occurs where two or more N-to-many joins exist. However, since the joins for which corrective action is taken may be arbitrarily selected, taking corrective action with respect to less than all of the joins may confuse the user as to the basis of selection. Accordingly, it is also contemplated that corrective action may be taken with respect to all of the identified N-to-many joins.

Referring now to FIG. 3, one embodiment of a method 300 for detecting conditions responsible for resulting in Cartesian Products (e.g., Cartesian Product 152 of FIG. 1B) in query results (e.g., query result 150 of FIG. 1B) is shown. At least part of the steps of method 300 can be performed by a query manager (e.g., query manager 140 of FIG. 1A). Method 300 starts at step 310.

At step 320, a query (e.g., query 120 of FIG. 1B) having a plurality of joins (e.g., joins 124 and 126 of FIG. 1B) is received from a requesting entity. At step 330 the joins from the plurality of joins are identified from the received query.

At step 340, the cardinalities of the identified joins are determined. According to one aspect, this determination can be performed on the basis of an analysis of the relations between the underlying database tables. This determination can further be performed by analyzing corresponding relationship definitions (e.g., the relationship specification of Table II). Moreover, this determination can be performed using provided definitions of cardinalities of the joins (e.g., definitions 212 and 214 of FIG. 2A).

At step 350, a join graph (e.g., join graph 220 of FIG. 2A) is constructed. The join graph is constructed on the basis of the identified joins and the determined cardinalities. At step 360, the join graph is analyzed. In one embodiment, the join graph is analyzed to determine whether more than one branch of the join graph includes a double lined connection that represents a one-to-many join. Accordingly, at step 370 conditions responsible for resulting in a Cartesian Product are detected in the query result without executing the query if more than one branch having a one-to-many join has been identified at step 360.

At step 380, a notification is provided to the requesting entity indicating that the conditions responsible for resulting in the Cartesian Product have been detected in the query result. For instance, feedback such as a warning flag is provided to the requesting entity which allows the requesting entity to recognize that the conditions responsible for resulting in the Cartesian Product have been detected. Method 300 then exits at step 390.

While the foregoing is directed to embodiments of the present invention, other and further embodiments of the invention may be devised without departing from the basic scope thereof, and the scope thereof is determined by the claims that follow.

What is claimed is:

1. A method for detecting Cartesian Products in query results, comprising:
identifying, from a query against one or more databases, joins between different tables of the one or more databases; and
determining on the basis of cardinalities of the identified joins whether a Cartesian Product will occur in a query result corresponding to the query, without executing the query against the one or more databases.

2. The method of claim 1, wherein the determining comprises:
detecting a condition in the cardinalities of the identified joins that will result in occurrence of the Cartesian Product.

3. The method of claim 1, further comprising:
determining the cardinalities of the identified joins by analyzing the different tables of the one or more databases.

4. The method of claim 1, further comprising:
determining the cardinalities of the identified joins from relationship definitions included with a data abstraction model abstractly describing the data in the one or more databases.

5. The method of claim 1, further comprising:
constructing a join graph representing the identified joins and the cardinalities of the identified joins.

6. The method of claim 5, further comprising:
identifying, from the join graph, joins having cardinalities defining one of (i) one-to-many and (ii) many-to-many relationships between corresponding tables; and
wherein it is determined that the Cartesian Product will occur if the join graph includes two or more joins having cardinalities defining the one of (i) one-to-many and (ii) many-to-many relationships.

7. The method of claim 5, wherein the join graph comprises two or more branches connected to a star point, each branch including one or more identified joins, the method further comprising:
for each branch of the join graph;
traversing the branch to identify the included joins; and
determining the cardinalities of each included join to identify joins having cardinalities defining one of (i) one-to-many and (ii) many-to-many relationships between corresponding tables; and
wherein it is determined that the Cartesian Product will occur if the join graph includes two or more branches including joins having cardinalities defining the one of (i) one-to-many and (ii) many-to-many relationships.

8. The method of claim 1, further comprising:
notifying a user if it is determined that the Cartesian Product will occur in the query result.

9. The method of claim 1, further comprising:
associating the query with a warning flag to indicate that it is determined that the Cartesian Product will occur in the query result.

10. The method of claim 1, wherein the query is composed using logical fields defined by a data abstraction model abstractly describing the data in the database.

11. The method of claim 10, wherein each logical field is mapped to one or more physical entities of data of an underlying data representation being used in the one or more databases.

12. The method of claim 1, wherein the query is a SQL query.

13. A method for detecting Cartesian Products in query results, comprising:
constructing, for a query, a join graph representing joins between a plurality of tables of one or more databases;
traversing the join graph from one table to another table for each of the plurality of tables; and
determining, on the basis of the traversing and without executing the query, whether a predetermined type of condition exists in the join graph which is capable of contributing to a resulting Cartesian Product in a query result corresponding to the query.

14. The method of claim 13, wherein the predetermined type of condition comprises a N-to-many join in the join graph.

15. The method of claim 13, wherein determining the predetermined type of condition capable of contributing to the resulting Cartesian Product comprises determining the cardinalities of the joins.

16. The method of claim 13, further comprising determining, on the basis of the predetermined type of condition in the join graph that wherein determining the predetermined type of condition capable of contributing to the resulting Cartesian Product comprises identifying at least two N-to-many joins in the join graph.

17. The method of claim 13, further comprising:
determining that the Cartesian Product will result in the query result on the basis of the predetermined type of condition existing in the join graph; and
notifying a user of the Cartesian Product without executing the query.

18. A computer-readable medium containing a program which, when executed by a processor, performs a process for detecting Cartesian Products in query results, the process comprising:
identifying, from a query against one or more databases, joins between different tables of the one or more databases; and
determining on the basis of cardinalities of the identified joins whether a Cartesian Product will occur in a query result corresponding to the query, without executing the query against the one or more databases.

19. The computer-readable medium of claim 18, wherein the determining comprises:
detecting a condition in the cardinalities of the identified joins that will result in occurrence of the Cartesian Product.

20. The computer-readable medium of claim 18, wherein the process further comprises:
determining the cardinalities of the identified joins by analyzing the different tables of the one or more databases.

21. The computer-readable medium of claim 18, wherein the process further comprises:
determining the cardinalities of the identified joins from relationship definitions included with a data abstraction model abstractly describing the data in the one or more databases.

22. The computer-readable medium of claim 18, wherein the process further comprises:
constructing a join graph representing the identified joins and the cardinalities of the identified joins.

23. The computer-readable medium of claim 22, wherein the process further comprises:
identifying, from the join graph, joins having cardinalities defining one of (i) one-to-many and (ii) many-to-many relationships between corresponding tables; and
wherein it is determined that the Cartesian Product will occur if the join graph includes two or more joins having cardinalities defining the one of (i) one-to-many and (ii) many-to-many relationships.

24. The computer-readable medium of claim 22, wherein the join graph comprises two or more branches connected to a star point, each branch including one or more identified joins, the process further comprising:
for each branch of the join graph;
traversing the branch to identify the included joins; and
determining the cardinalities of each included join to identify joins having cardinalities defining one of (i) one-to-many and (ii) many-to-many relationships between corresponding tables; and
wherein it is determined that the Cartesian Product will occur if the join graph includes two or more branches including joins having cardinalities defining the one of (i) one-to-many and (ii) many-to-many relationships.

25. The computer-readable medium of claim 18, wherein the process further comprises:
notifying a user it is determined that the Cartesian Product will occur in the query result.

26. The computer-readable medium of claim 18, wherein the process further comprises:
associating the query with a warning flag to indicate that it is determined that the Cartesian Product will occur in the query result.

27. The computer-readable medium of claim 18, wherein the query is composed using logical fields defined by a data abstraction model abstractly describing the data in the database.

28. The computer-readable medium of claim 27, wherein each logical field is mapped to one or more physical entities of data of an underlying data representation being used in the one or more databases.

29. The computer-readable medium of claim 18, wherein the query is a SQL query.

30. A computer system comprising:
one or more databases; and
a query manager configured for:
identifying, from a query against the one or more databases, joins between different tables of the one or more databases; and
determining on the basis of cardinalities of the identified joins whether a Cartesian Product will occur in a query result corresponding to the query, without executing the query against the one or more databases.
